(19) United States
(12) Patent Application Publication
(10) Pub. No.: US 2019/0002356 A1
(43) Pub. Date: Jan. 3, 2019

(54) IMPROVED PROCESS FOR PRODUCING SILICA AEROGEL THERMAL INSULATION PRODUCT WITH INCREASED EFFICIENCY

(71) Applicant: Neha Yeshwanta HEBALKAR, Hyderabad (IN)

(72) Inventor: Neha Yeshwanta HEBALKAR, Hyderabad (IN)

(21) Appl. No.: 15/744,011

(22) PCT Filed: Jul. 4, 2016
(86) PCT No.: PCT/IN2016/000176

§ 371 Date: Jan. 11, 2018

(30) Foreign Application Priority Data
Jul. 15, 2015 (IN) 2141/DEL/2015

(51) Int. Cl. C04B 35/80; B32B 5/02; B32B 5/24; D04H 1/4209; D04H 1/413; D04H 1/4218; C04B 35/624; C04B 35/626; C04B 35/628; E04B 1/80

(52) U.S. Cl. CPC C04B 35/803; F16L 59/026; B32B 5/245; D04H 1/4209; D04H 1/413; D04H 1/4218; C04B 35/624; C04B 35/62635; C04B 35/62878; E04B 1/80; B32B 2260/021; B32B 2260/04; B32B 2262/105; B32B 2264/102; B32B 2307/304; C04B 2235/3418; C04B 2235/483; C04B 2235/3232; C04B 2235/5454; C04B 2235/5216; C04B 2235/616; C04B 2235/9607; B32B 5/022

(57) ABSTRACT

The invention relates to an improved method for producing silica aerogel in pure and flexible sheet form having effective suppression of radiative heat transport at high temperatures and increased thermal insulation property. The suppression of radiative heat transport was achieved by in-situ production of titanium dioxide nanoparticles in very minor concentrations during gelation of silica precursor, with nanoporous surface area more than 300 m2/g and acts as an infra red reflecting agent. When aerogel is subjected to heat during hot object insulation, it automatically turn into infra red reflecting material. Said silica aerogel can be incorporated into the inorganic fibre mat matrix individually or into two or more layers with organic sponge sheet placed in between and stitched together to form a sandwich sheet to form highly insulating flexible sheet.

### FIELD OF THE INVENTION

The present invention relates to an improved method for producing silica aerogel in pure and flexible sheet form having enhanced suppression of radiative heat transport at high temperatures and increased thermal insulation property. More especially a process for producing silica aerogel thermal insulation product having metal oxide nanoparticles formed in situ in silica aerogel. A novel approach was used to achieve the radiative heat transport at high temperatures using a small fraction of infra red opacifier material. The silica aerogel flexible sheet product prepared by the method described in this invention, has more content of silica aerogel than the sheets prepared by known methods. This sheet is capable of showing higher thermal insulation property.

### BACKGROUND OF THE INVENTION

Aerogels are known as ultra low density, nanoporous, man made materials having unique combination of sound, electricity and heat insulation capacity. There is a vast literature available on their preparation, properties and applications. Large number of studies has been carried out so far to understand the relationship between reaction parameters with porosity, behaviour of thermal insulation in various conditions, varying the compositions, having different functionalities such as hydrophilic and hydrophobic nature, crosslinking to have flexible mechanical properties and so on. It is seen that large number patents are granted on above various aspects. The aerogels are commercially produced in various forms such as granules, sheets etc.

Literature illustrates variety of aerogel applications such as thermal insulator, cosmic dust collector, drug delivery carrier, sound absorber, supercapacitors, electrode material in batteries, fuel cells and so on. From all the above, thermal insulation is the most popular, well studied and proven application and has been explored in many insulation fields such as industrial, aerospace, textile, footwear, sports articles, hot-cold storages, automobiles, architectural etc.

The aerogels are best thermal insulators as their low density and nanoporous morphology minimizes the heat transport through conduction and convention process due to the low solid content and smaller pore size in them respectively. The silica aerogel structure is stable in higher temperatures so that the thermal insulation property is retained upto 1000° C. Silica aerogels have smaller infra red radiation absorption which contributes to the heat transport which minimal at ambient temperature and its contribution increases at higher temperatures due to higher emissivity. Generally this problem is tackled by incorporating infra red absorbing or reflecting materials into the aerogel.

Another importantly required feature of silica aerogels to use as thermal insulation material is hydrophobic nature. Generally all the conventional thermal insulation materials such as glass wool, when absorb atmospheric humidity the insulation performance is drastically reduced with time as water has higher thermal conductivity. The hydrophobic property in aerogels keeps them in good performance for several years as it keeps away the moisture.

Aerogels in the pure form are fragile in nature and hence its use in large scale commercial application was restricted. However, in the present time, pure aerogels are being used as an additive to make thermally insulating composites and are used in many applications. Several efforts were engaged in finding different convenient forms of it. This mainly led to develop the aerogels in granular form and composite of them with fibres giving flexible natured sheets. Aerogel granules used as thermal insulator by making composites, sandwich between substrates etc. We already have applied patent for novel process developed for making silica aerogel granules (Application No. 2406/DEL/2010). For majority of the thermal insulation applications, flexible sheets are found the most suitable and convenient.

Making of sheets is mainly done by preparing composite of aerogel with fibrous material. Mixing of aerogel powder with fibres and some binders and then calendaring the mixture in the form of sheet by rolling is one patented method. In another method, the flexible sheet is prepared by soaking the fibre blanket in silica sol followed by gelation of the sol to form a gel-fiber composite sheet and then further drying it at supercritical condition to form flexible aerogel sheet. In this sheet, the pores of the fibrous blanket are filled by aerogel. The limiting factor of aerogel loading in the sheet is the porosity in the fibre blanket. The blankets are available in various densities and the lowest density commercially and commonly available is generally about 100 g/m³. This leads to maximum 50-60 weight percent loading of aerogel in the sheet in the given thickness.

Other additives which give rise to opacification of infra red radiation are mixed in the composite aerogel sheet which becomes useful to minimize the radiative heat transport at above ambient temperatures. The enveloping the aerogel sheets in different fabric, polymers to give protective cover is also patented.

The present invention aims to increase the aerogel content in the sheet by incorporating aerogel granules sandwiching them between two aerogel sheets. Second objective was to improve the IR opacification functionality by using nano additives which are in-situ prepared while silica gel formation.

### PRIOR ART

It is known that silica aerogels are produced by sol-gel method where the silica procure is first hydrolysed and then poly-condensed to form silica gel. Commonly used silica precursors are sodium silicate, tetra ethyl orthosilicate (TEOS), tetra methyl orthosilicate (TMOS), hexamethyldisilazane (HMDS), methyl trimethoxysilane (MTMS) etc. Most popular silica precursor is TEOS which has simple and quick process of making gel. Alcohols are used as solvents which include methanol, ethanol, propanol, butanol etc. Water in certain proportion is required as a hydrolyzing agent for the silica precursors. Acid, base or combination of them is used as a catalyst. The precursor is mixed in solvent, catalyst and water mixture and stirred to form a sol. Sol converts into gel due to the poly-condensation reaction. The hydrophobic silica aerogels are formed by surface modification by alkilation process or using alkyl group containing co-precursors. The infra red opacifiers are introduced in silica aerogel by addition of opacifying agents such as titanium dioxide. The silica sol is in-filtered into a fiber matrix to make a composite or flexible sheet. All these forms of gels are then dried by most popular super critical drying process to be carried out in an autoclave which can be performed using alcohol or liquid carbon dioxide as a solvent. There is a vast literature available on this subject.

The infra red opacification of aerogel, process of aerogel formation in its pure form and flexible sheet are the key points to be discussed in relevance with the preferred embodiments claimed in this patent. The prior art given below mainly emphasize on these points as other factors and process parameters are similar to the explained one above.

Following are some important and relevant patents where the manufacturing of silica aerogel composites with fibres in the form of non-flexible or flexible sheet, formation of the aerogel sheet by sandwiching the silica aerogel between two encapsulating layers and use of infra red opacifier additive in them is described.

The preparation of aerogel composite with fibres where fibres of various lengths are random distributed in aerogel matrix or aerogel is in-filtered in woven or non-woven fibre mat to make flexible aerogel composites are claimed in few patents.

Making of aerogel and fibre composites in the form of flexible sheets is not a new concept. The old patent U.S. Pat. No. 5,306,555 in 1992 and U.S. Pat. No. 5,789,075 in 1995 describes the process for preparation of an aerogel—fiber composite. This composite comprises fibers randomly distributed throughout the monolithic aerogel or fibers in the form of mat or sheet with and without opacifiers respectively. In these processes, silica sol is prepared and mixed it with fibers followed by gelation and supercritical drying.

The patent U.S. Pat. No. 6,068,882 describes a process of silica aerogel composite with fibers. The fibers are pre-coated with carbon which acts as infra red absorber. Such carbon coated fibers were then in-filtered with silica sol, followed by gelation and supercritical drying. This patent does not include in-situ formation of metal oxide as infra red reflecting material. Also it has not claim to form sandwich type of flexible aerogel sheet formation.

The family patents WO2002052086A2, US20020094426A1, BR200115523A, EP1358373A2, AU2002232688A1, JP2004517222A, KR2004030462A, IN200300648P2, CN1592651A, MX2003004333A, U.S. Pat. No. 7,078,359B2, US20060199455A1, CN1306993C, RU2310702C2, IL155922A, MX247570B, U.S. Pat. No. 7,504,346B2, KR909732B1, US20090229032A1, CA2429771C, IN219944B, JP2012182135A, describes the process of making aerogel composite materials having a lofty fibrous batting reinforcement preferably in combination with individual short randomly oriented microfibers. It also may have conductive layers exhibiting improved performance in one or all of flexibility, drape, durability, resistance to sintering, planer thermal conductivity, planer electrical conductivity, RFI-EMI attenuation, and/or burn-through resistance. Supercritical drying process using carbon dioxide as a solvent is used in making of these aerogel sheets. These patents mention use of infra red opacifiers as dopent used as an additive. The infra red opacifier are added externally and not prepared in-situ in the concentration of 1-10%. Disadvantage of the process where any dopent material added externally by dispersing in the sol, it settle down very fast and hence uniform distribution of them in the further formed gel from sol is not possible. To avoid settlement, some dispersing agents need to be added which is an added cost and added step in the preparation process and unwanted addition of extra component in aerogel composition. Additionally they are needed in larger volume unlike as mentioned in the present invention. Also these do not claim to form sandwich type of flexible aerogel sheet formation.

The family patents US20070222116A1, U.S. Pat. No. 7,560,062B2, claim nanoporous aerogel reinforced with fibrous materials where the aerogel is mixed with the fibres and mechanically compressed to form a composite of aerogel reinforced with fibrous material through compressing unit with increase density. This is a dry method of making aerogel sheets where preformed aerogel is used for making the composite. The aerogel used in this process is preformed.

The family patents WO2013131807A1, IT1410250B, AU2013229645A1, EP2822757A1, CN104203558A, US20150082590A1, IT2012PD0065A1, describe a method for providing mat containing aerogel, involves immersing ribbon of fabric or non-woven fabric unwound from reel in solution containing aerogel in suspension, and winding dried ribbon containing aerogel onto rewinding reel. In this process aerogel is preformed and its suspension is used for making aerogel mat. This patent does not include the method of infiltration of silica aerogel into fibre mat and the aerogel used in this process is preformed.

The family patents WO2007146945A2, US20090029147A1 and KR2012054389 sol of silica aerogel is in-filtered into the open cell organic foam having specific pore size, and further the composite of silica gel and foam is dried supercritically using carbon dioxide as a solvent. The silica aerogel is formed within the pores of the organic foam and organic foam remains intact during supercritical drying as it is performed at lower temperatures as carbon dioxide has critical temperature at 31° C. The flexible sheet made as per the claims of this patent contains organic foam and not the fibre mat or any sandwich structure in the composite mat.

The patent KR1195436B1 describes a process for manufacturing aerogel sheet using needle punched non-woven fabric by dry process. The aerogel sheet includes a needle-punched non-woven fabric, and aerogel particles charged in the fabric. The aerogel particles are scattered or charged in the voids of needle-punched non-woven fabric web and laminating the main needle-punched non-woven fabric web by thermally treating surfaces covered by polymer layer or the upper and lower non-woven fabric webs firmly attaching to each other by bridged fibres, without a binder. Infrared opacifier is additionally charge into woven fabric. The opacifier is chosen from carbon black, titanium dioxide, iron oxide and zirconium dioxide. This process needs the preformed aerogel to make a composite. The opacifier material mixed in the composite as an external additive and not in-situ prepared. Charging process of opacifier into fabric is not claimed.

The patent JP04014635B2 describes a process to produce fibrous structure of aerogel composite material. The invention relates to a composite material comprising fibres and aerogel particles and one of the fibrous formations contains at least one thermoplastic fibrous material to which the aerogel particles are bound and by which the fibres in the formation are bound together. It can have an additional coating layer of material from a group plastic film, a metal film, the plastic film with metal coating or thin simple fibre. The aerogel used in this process is preformed.

The patent US 2012/0238174 A1 describes the composite where fibre-reinforced aerogel layer is enclosed or covered by at least one fiber containing layer and also comprising functional layer having radiation absorbing, reflecting, blocking property or thermally or electrically conductive layer. This patent describes a method of enclosing preformed fibre-reinforced aerogel layer and the opacifier material is mixed in the composite as an external additive and not in-situ prepared.

The patent US20130308369 A1 describes the lamination of fiber-reinforced aerogel layer by composite material containing resin matrix on one side and backing layer on other surface. This patent describes a method of enclosing preformed fibre-reinforced aerogel layer.

The patent CN102010179A claims a method for preparing silica aerogel composite insulation material consisting of fibre, drying controlling agents, infrared opacifier adding in precursor solution of the aerogel to form composite gel, then processing the composite gel to acquire the silica aerogel composite powder with fibre. To this small amount of binding agent is added to mould and perform thermal processing to acquire composite products with different shapes. The process explained here is too complex where composite of silica aerogel with fibres is made first in powder form which is then mixed with binder and given desired shape by moulding it and final product is prepared by thermally treating these moulds. The opacifier material mixed in the composite is as an external additive and not in-situ prepared.

The patent CN101628804A gives a process to make aerogel heat-insulated composite material comprises silica aerogel, infrared opacifier titanium dioxide, and reinforcing fiber. The filler from the following group of materials such as kaolin, attapulgite, sepiolite, wollastonite, diatomite, and silicon micropowder is added to the composite. The method of silica aerogel formation includes formation of silica gel using where sodium silicate, chemical drying control agent, and glycol and catalyst and then drying of the washed get 10-20 hours at 110-150° C. to obtain porous silica. Powder. In the precursor solution, opacifier, reinforcing fiber and filler is added preparing mixed paste. This mixed paste is infused into die through casting process and the molded sample is dried. Titanium dioxide is added externally and not prepared in-situ. The opacifier material mixed in the composite as an external additive and not in-situ prepared.

The patent CN101671156A and CN101671157A claims a composite with 40-80% of SiO₂ aerogel, 5-40% of infrared opacifier and 0-25% of reinforced fibre in xonotlite fibre material. The invention comprises winding of ultra-fine xonotlite fibre with silica to form xonotlite-aerogel composite powder, uniformly mixing with infrared opacifier and reinforced fibre, compressing and forming in forming device with negative pressure device. The aerogel used in this process is preformed. The infra red opacifier are added externally and not prepared in-situ. The aerogel used in this process is preformed and the infra red opacifier used is in large volume and are added externally and not prepared in-situ.

The patent U.S. Pat. No. 8,214,980B2 describes a process to make a laminate comprising layer(s) of fiber-containing material is disposed adjacent to fiber-reinforced aerogel layer(s) securing fiber-reinforced aerogel layer to layer of fiber-containing material. The fiber-reinforced aerogel layer comprises diatomite, boron carbide, manganese ferrite, manganese oxide, nickel oxide, tin oxide, silver oxide, bismuth oxide, titanium carbide, tungsten carbide, carbon black, titanium oxide, iron titanium oxide, zirconium silicate, zirconium oxide, iron(I) oxide, iron(II) oxide, manganese dioxide, iron-titanium oxide, chromium oxide and/or silicon carbide as an additive. The fiber-reinforced aerogel layer has hydrophobic component. The infra red opacifier are added externally and not prepared in-situ.

The patent CN102010179A describes a process to make silica aerogel composite where silicon sol is prepared with infrared opacifier, drying-control additive and fibers. This precursor solution is condensed, and solvent substitution is performed, aged and dried to obtain composite powder. A binder is added to the obtained composite powder. The obtained composite powder is moulded and thermally processed to obtain composite insulating material. The infra red opacifier are added externally and not prepared in-situ.

The patent WO2008051029A9 gives a method of making of aerogel sheet comprising a 10-90 wt. % hydrophobic aerogel particles charged in the non-woven polymer fabric and is laminated by thermally treating surfaces to obtain aerogel sheet. Infrared opacifier from carbon black, titanium dioxide, iron oxide, and zirconium dioxide is additionally charged into woven fabric. The polymer is chosen from polyester, polyamide and polyolefin. The aerogel used in this process is preformed and the infra red opacifier are added externally and not prepared in-situ.

Patent US20070173157A1 describes a method of manufacturing aerogel structure comprising at least one polymeric or inorganic fibrous layer infused with a continuous matrix of an aerogel material, secured with an adhesive to a polymeric sheet. The opacifying compound is added to the matrix from the range of materials boron carbide (B4C), diatomite, manganese ferrite, manganese oxide, nickel oxide, tin oxide, silver oxide, bismuth oxide, titanium carbide, tungsten carbide, carbon black, titanium oxide, iron titanium oxide, zirconium silicate, zirconium oxide, iron (I) oxide, iron (III) oxide, manganese dioxide, iron titanium oxide (ilmenite), chromium oxide and/or silicon carbide. The aerogel used in this process is preformed and the infra red opacifier are added externally and not prepared in-situ.

Patent E202011050486U1 comprises an insulation sheet with two spaced surface substrates, a supporting structure, which is interiorly arranged between these substrates with filling of aerogel material in the intermediate spaces and is closed in gas-tight manner. The aerogel used in this process is preformed.

The patent U.S. Pat. No. 6,479,416 describes a method of manufacturing fibrous aerogel composite material produced by sandwiching silica aerogel granules between the thermoplastic fibre layers and pressing them under temperature to form a composite material. The aerogel used in this process is preformed.

The patent US 2002/0025427 A1 claims a process of making multilayer composite materials of sandwich structure of at least aerogel containing layer with binder and coupling agents in the multilayer structure where other enclosing layers may be any type of material which can combine with aerogel containing layer. The aerogel used in this process is preformed.

The patent CN101469803A describes a method of preparation of aerogel based high temperature resistant material where silica aerogel is placed between the two layers of the high temperature inorganic fibre cloth made up of glass fibre, high alumina fibre, carbon fibre and silicon carbide fibre. The aerogel used in this process is preformed.

The patent EP 2 281 962 A2 claims a method of producing a composite material comprising a fibrous material dispersed with an aerogel, wherein said fibrous material is selected from the group consisting of natural fibers, mineral wool, wood wool, and a combination thereof. The said fibrous material is applied with binder on it and the aerogel is also treated with water glass, a mineral wool binder, or an organic binder before it is applied to the fibrous material. The aerogel used in this process is preformed.

Patent US 2011/0281060 describes the formation of flexible sheet comprising of core layer of aerogel encapsulated in flexible facing cover material. The aerogel used in this process is preformed.

Patent CN201269022Y claims making of an energy-saving window containing silica filled between two layers and embedded in solid steel, aluminium alloy, plastic steel or wooden window frame and the frame is fixed using caulking chutes, plastic sealing and a silicon dioxide nano insulating plaster. The aerogel used in this process is preformed

The patent JP2012145204A describes the formation of heat insulating material which consists of a fibre base material filled with aerogel and for the purpose of prevention of the dust generation, covering with the exterior body consisting of the woven fabric of inorganic fibre. It also uses an additive of the light scattering titanium dioxide micron or sub micron sized particles to improve thermal insulation at higher temperature. The aerogel used in this process is preformed and the infra red opacifier are added externally and not prepared in-situ.

The patent CN102613245A describes a preparation method of silica comprising the steps of mixing ethyl orthosilicate and titanium compound first and then mixing it with the alcohol solvent. The slowly adding the dilute ammonia water till the pH value of the solution to be 7-10, with continuously stirring. The solution terns into gel which is dried to obtain the silica-titania composite aerogel. The method attaches nanometre-grade titanium dioxide to the high specific surface area of silica aerogel, which effectively prevents agglomeration of the nano titanium oxide and increase the activity of titanium oxide. The silica—titania composite preparation claimed in this patent is not specified for infra red opacifier application, but for other properties of titania like antibacterial, self cleaning, solar cell etc. The titanium compound used in the preparation process includes titanium dioxide powder, titanium tetra chloride, titanyl sulphate or tetrabutyltitanete. Addition of titanium dioxide powder to silica is not a novel process. The titanium tetrachloride and titanyl sulphate are highly acidic in nature which lowers the pH of silica sol tremendously when added. In addition, they are corrosive and irritant and leaves chloride/sulphate ions as bi-products which are difficult to wash away. If they are not removed, the formed product will be corrosive to the metal where it is applied as insulation material and this is completely an undesired property. The patent does not include the titanium precursor titanium isopropoxide.

The patent CN1749214A describes a process of making silica aerogel composite consisting of silica aerogel, titania as infrared opacifier and reinforcing fibre in the weight ratio of 1 to 0.1-0.7 to 0.7-3. Its preparation process includes mixing of titanium dioxide sol which was prepared separately in silica sol prepared in alcohol solvent with acid catalyst and alkaline catalyst in certain proportion. In which the fiber felt or prefabricated fibre is soaked dried supercritically. The titania as an infra red opacifier is added externally and not prepared in-situ.

The patent WO2011066209A2 and CN104261797 describes use of titania as an additive infra red opacifier in aerogel composite.

The patent CN100398492C describes the silica aerogel composite where titania is added as infra red opacifying material. As per the process disclosed, addition of titania in silica is done by mixing of silica sol with titania sol which can normally lead to the formation of Si—O—Ti bonding unlike the precipitation of titania and then trapping of it in silica matrix as disclosed according to our invention.

The patent CN103203206A describes a method of where titania particles are coated with cellulose and then silica precursor is added to it to form cellulose/titania/silica aerogel. The presence of cellulose does not allow the supercritical drying in organic solvents as at it degrades. It also hampers the infra red reflection properties of titania. As per the description in the patent, the purpose of having cellulose is to make the material bio-compatible. The process claimed is very different unlike of this invention.

All the above patents describe making aerogel composite with fibres with different compositions, with different methods. These composites are prepared in different forms including flexible or non-flexible sheets. Different ways claimed are in-filtration of aerogel into the fibrous matrix, sandwiching of aerogel powder between different securing layers, making laminate of aerogel fibrous sheet using various sheets, cloth, fabric, foils etc. Most of the methods include addition of infra red opacifiers including titanium dioxide in the composite where this additive is not specifically claimed to have particle size in nanometre range. No patent mentions in-situ formation of titanium dioxide nanoparticle which is capable of automatically infra red reflecting when subjected to heat while insulating hot object. The process described in the present innovation lead to formation of highly nanoporous aerogel in pure form or in the sheet form having surface area above 500 m²/g. None of the above mentioned patents discloses any surface nanoporous area for the aerogels formed by respective processes. However, when compared to the available products in the market made using the processes mentioned in the above patents, the present innovations gives the nanoporosity 2 to 4 times higher which is a major cause of the thermal insulation property. This novel feature of the invention is illustrated in one of the examples described later on, in the subsequent paragraphs. According to our invention, method of making flexible sheets by sandwiching silica aerogel granules between layers of aerogel in-filtered fibrous sheets is unique, novel and not reported till date.

### OBJECTIVES OF THE PRESENT INVENTION

The main object of the present invention is to provide an improved method for producing silica aerogels having capability of effectively suppressing radiative heat transport with a simple method and increasing the thermal insulation than the aerogels flexible sheets prepared by conventional processes.

Another objective of the present invention is to provide an improved method for producing silica aerogels which have effective radiative heat suppressing property by adding a metal oxide precursor into the solvent mixture before addition of silica precursor in such a way that amorphous titania nanoparticles are precipitated before formation of silica where even the smallest concentration i.e. 0.1% of metal oxide shows drastic improvement in the infra red reflection property when compared to the one without titania.

Another objective of the present invention is to provide improved method of producing silica aerogels to achieve hydrophobic or hydrophilic property by selection of appropriate silica precursors along with the effective radiative heat transfer suppressing property.

Another object of the present invention is to provide an improved method for producing silica aerogels as mentioned above which is cost effective, faster and simple.

Yet another objective of the present invention is to in-filter the silica aerogel with all the above properties into the inorganic fibre mat to prepare a thermally insulating flexible aerogel sheet.

Yet another objective of the present innovation is to produce the silica aerogel in-filtered inorganic fibre mat composite having surface area above 300 m²/g.

Yet another objective of this invention is to provide a novel method to increase the aerogel content in the fibre re-inforced silica aerogel flexible sheet by sandwiching the silica aerogel granules with all above properties between the two layers of silica aerogel fibre re-inforced sheets.

Yet another objective of this invention is to achieve the nanoporous surface area of the composite sheet made up of silica aerogel granule sandwiched between fibre re-inforced silica aerogel flexible sheet above 500 m²/g.

The above objectives of the present invention have been achieved due to our findings based on extensive R & D carried out that involves entrapping amorphous titania nanoparticles uniformly distributed through out the porous network in silica aerogel. The silica aerogel when exposed to heat during its application as thermal insulation, starts showing its infra red radiation reflecting property. This property enables in turn to improve the thermal insulation functionality at higher temperatures by suppressing radiative heat transfer. In another innovation, such silica aerogel can be made into fibre re-inforced flexible sheet with improved thermal insulation property by increasing the aerogel content in the sheet by sandwiching granules of above mentioned silica aerogel between two silica aerogel flexible sheets.

### SUMMARY OF THE INVENTION

Accordingly the present invention provides an improved process for producing silica aerogels in pure and flexible sheet form having enhanced suppression of radiative heat transport at high temperatures and increased thermal insulation property. The suppression of radiative heat transport was achieved very efficiently by producing the metal oxide nanoparticles in-situ which gets trapped uniformly in silica network during gel formation. When silica aerogel product with metal oxide nanoparticles preferably titanium dioxide nanoparticles dispersed in it is applied on hot object for thermally insulation, the heat in the surface initiates the crystallization of nano titanium dioxide and automatically starts reflecting infra red radiation and in turn suppresses the radiative heat transport. As it is known that the volume of material enormously increases at nano size and it is true for metal oxide nanoparticles in this case. Hence the smaller fraction such as 52% of metal oxide nanoparticles formed according to our invention show the enhanced infra red radiation reflection than the micron sized particles with fraction of 1-40% as disclosed in some patents and published papers.

The thermal insulation property is directly related to the quantity and quality of the aerogel in aerogel product. In this invention, the thermal insulation property was increased by increasing the silica aerogel volume in the sheet. The increased silica aerogel volume was achieved by sandwiching the silica aerogel granules in between the layers of inorganic fibre mats in-filtered with silica aerogel. Such sandwiching was carried out by a novel approach where an organic sponge sheet as a template was sandwiched between layers of inorganic fibre mats and stitched together in a manner to close the edges and form grid structure. The thread used for stitching can be of any suitable thickness and composition depending upon the thickness of sheet and the usage temperature in the application. For usage at high temperature, the stitching thread is preferably made up of the fibers or yarn of silica, silica-alumina, zirconia with or without metal thread re-inforcing and metal threads. The silica sol which is converted into gel, get in-filtered in to the pores of this stitched sheet. While supercritical drying of this gel composite, the organic sponge degrades to release silica granules in its pores and these granules are placed into the pockets formed due to the grid like stitching. The total silica aerogel granule content in the sheet can be tailored by changing the thickness of organic sponge sheet and its number of layers. Similarly two or more layers inorganic fibre mat with organic sponge sheet placed in between the layers can also be used before stitching together to form a sandwich sheet of desired size, shape and thickness.

The flow chart showing the important steps of the manufacturing process are shown in the FIG. 1.

In another embodiment under the invention instead of said sandwich sheet, individual inorganic fibre mat of desired size, shape and thickness with aerogel can also be formed by soaking in the aerogel formed followed by supercritical drying as shown in the flow diagram in FIG. 2.

In yet another embodiment under the invention instead of said sandwich sheet and individual inorganic fibre mat with aerogel, the liquid gel formed can be poured into the mould followed by supercritical drying to form the silica gel in pure form having the desired size, shape and thickness as shown in the flow diagram in FIG. 3.

### BRIEF DESCRIPTION OF DRAWING

These and other features, aspects and advantages of the present invention will become better understood when the detailed description is read with reference to the accompanying figures and drawing.

FIG. 1: Flow chart showing the formation of silica aerogel granules infiltrated flexible sheet sandwiched with organic sponge sheet in between according to one preferred embodiment under the invention.

FIG. 2: Flow chart showing the formation of silica aerogel granules infiltrated flexible sheet according to another embodiment under the invention.

FIG. 3: Flow chart showing the formation of pure silica aerogel produced according to the invention

FIG. 4: Schematic of the stitching pattern of inorganic fibre mat—organic sponge sheet—inorganic fibre mat sandwich

FIG. 5: Graph showing chemical analysis done by energy dispersive x-ray analysis (EDAX) of the sample as prepared in Example 1.

FIG. 6: Infra red reflectivity for the sample prepared by similar process described in Example 2 with variation in titanium dioxide content 0%, 0.1% and 1%

FIG. 7: Comparative graph on isotherm which plots the quantity of nitrogen adsorbed with respect to the relative partial pressure in nitrogen adsorption studies with the respective surface area for the silica aerogel in the flexible sheet prepared by a method as described in Example 2 and Example 4 and their comparison with the commercially available samples prepared by the process described in the patents mentioned in the prior art.

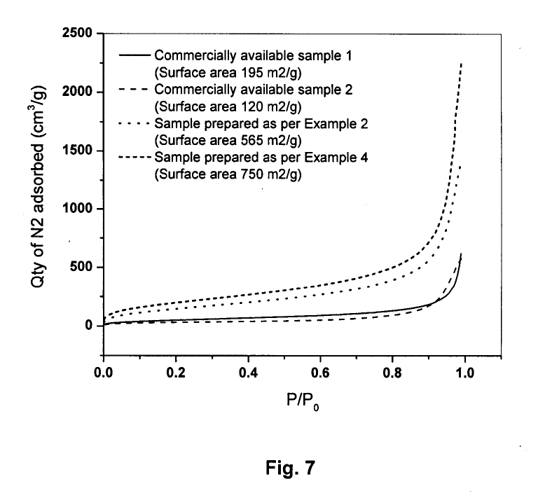

FIG. 8. Comparative graph on cumulative pore volume for the silica aerogel in the flexible sheet prepared by a method as described in Example 2 and Example 4 and their comparison with the commercially available samples prepared by the process described in the patents mentioned in the prior art.

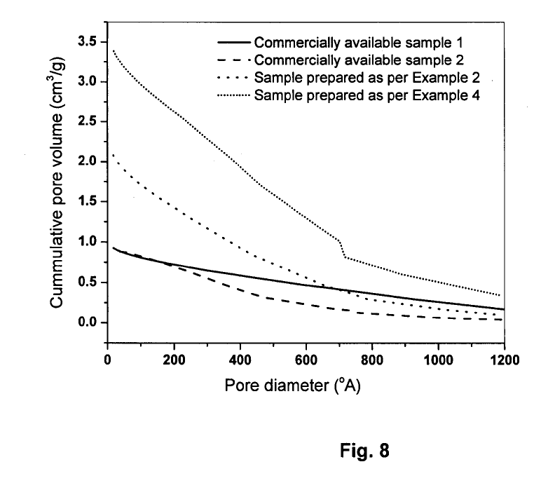

### DETAILED DESCRIPTION OF THE INVENTION

The most popular and promising application area of silica aerogels is thermal insulation. If compared with all the conventional high and cryo temperature insulation materials, silica aerogel tops the list of thermal insulation material in its class. Further being an inorganic material, it is structurally and chemically stable at wide temperature range in cryo and above ambient temperatures, which makes it a unique choice. Additionally its ultra low density is an additional advantage for insulation weight management. These advantages to silica aerogel are due to the nanoporous open network present in it which is being formed during its preparation by sol-gel method. The extent of this nanoporosity determines the density and thermal insulation property. Higher is the nanoporosity, better the thermal insulation property. The porosity in the silica aerogel is measured in terms of surface area, pore volume and pore area using the standard technique of nitrogen adsorption which is known as BET analysis. Typically pure silica aerogels possess specific surface area of about 500 to 1000 m²/g. When the composite of the silica aerogel is made by using fibre reinforcement to form the flexible or non flexible sheets, the specific surface area is reduced compared to the pure silica aerogel. The perfection in the manufacturing process can give rise to higher specific surface area even in the composite form, similar to the pure silica aerogel.

According to the process disclosed in the present invention, we are able to achieve high specific surface area due to the nanopores in the range of 1-100 nm.

The low density of aerogels leads to minimise the heat conduction through solid. The density has direct relation to the porosity and surface area in the silica aerogels. Hence higher the surface area and lower the density, lower the thermal conductivity in silica aerogels. The nano size pores having diameter less than the mean free path of air molecules at ambient pressure, minimizes the convectional heat flow. The average mean free path of the air molecules in ambient atmospheric pressure is about 70 nm. If majority of the pores in silica aerogel are equivalent or less than 70 nm, the heat transfer through the air is minimized to large extent. Hence to improve the thermal insulation property of silica aerogels, the pore size is to be controlled to achieve average pore size less than 70 nm. Another part of heat conduction is through radiation, mainly via infra red radiation. If the thermal insulation material can restrict the infra red radiation emitted by the heated object on which the insulation is applied, the heat losses will be minimized to greater extent. In the strategy to improve the thermal insulation performance, There are various ways by which thermal insulation performance, can be improved such as reducing the density further to low values by controlling the reaction parameter, controlling the pore size distribution, reducing the mean free path of air molecules by lowering the air pressure in the pores and finally combining the infra red reflecting material with silica aerogel by dispersing, enclosing, layering etc.

It is clearly seen from the prior art that, many types of infra red opacifiers are added to the silica aerogel or its composites, where it either absorb or reflect the said radiation. This invention deals with the infra red reflection property of aerogel. The concentration of such additives claimed in various patents varies in number. When infra red pacifiers are externally added to silica sol, the dispersion of such materials in the form of particles or fibres doses not guaranty the uniformity in distribution as these particles or fibres vary in density, surface chemistry and surface charge. If the same material is added in ultra small size, not only there is an improvement in the dispersion uniformity, but also results in the reduction of the quantity required to have same functionality. However, the production of such nanoparticles is a specialized process and lot of expertise is involved in doing so. Such nanomaterials are also available commercially in powder and dispersion form with higher cost. The dispersion of nanopowders in liquids is a challenge and it is a subject of R&D itself. Hence we have addressed this issue and have come out with easiest and cheapest way to produce such infra red opacifying dispersants in-situ in the silica porous network.

Among all the inorganic infra reflecting materials, metal oxides and among them titanium dioxide is the best known materials due to its temperature stability, abundance of occurrence in nature, cheaper price, compatibility of reaction conditions with silica forming reactions and aesthetics of bright white light reflecting colour and more importantly its ability to reflect the infra red radiation. The titania occurs in major three crystalline phases, anatase, rutile and brookite. Generally, as prepared titania by chemical sol-gel route in ambient condition is amorphous in structure. Thus formed amorphous titania when subjected to heating, starts becoming crystalline and may transform from anatase to rutile or directly in rutile structure depending on the reaction conditions of its preparation. Although both, anatase and rutile structured titania has infra red reflecting property, the rutile structure performs the best. It is known that due to the quantum size effects of nanoparticles, all the physical properties change as the size of the particles is reduced. The smaller particle size leads to the crystallization at lower temperature.

The silica-titania composite aerogels are well studied. Hitherto the mixed oxide aerogel such as silica-titania aerogel mainly focus on incorporating titania in silica to form Si—O—Ti bonding. This bonding is achieved by adding the mixture of silica and titania precursors to solvent-catalyst or making sols of silica and titania separately and then mixing together. Formation of ultra-fine particles dispersed in the solvents defined as ‘sol’. In fact when two sols are mixed, the two types of ultra fine particles, such as silica and titania, bond with each other to form Si—O—Ti bond. We do not envisage the prior art practice of forming Si—O—Ti bonding during the process of preparation of mixed oxide aerogel such as silica-titania aerogel, but prefer first precipitating titania in solvent-catalyst mixture and then trapping them in silica matrix formed later. The pure titania particles without any bond to silica are found to be more effective in infra red reflection than Si—O—Ti bonding.

The metal oxides such as iron, manganese, magnesium, zirconium, zinc, chromium, cobalt, titanium, tin, indium etc or mixtures thereof can be prepared in-situ using their salts or organometallic precursors. Titanium isopropoxide, butoxide, tetrachloride, trichloride, and sulphonate are various precursors used in the synthesis of titanium compounds. Out of which titanium isopropoxide and butoxide are the organometallic precursors which can take part in sol-gel reaction to form nano titania in certain reaction conditions. There will not be any unwanted by-products in the form of compounds and ions. Hence these two precursors are the most preferred ones. Both of these chemicals are most hygroscopic and react with water or moisture very vigorously. For any nanoparticle preparation, control over the rate of reaction is extremely important. So the precursor is initially diluted in alcohol and then used in the preparation. The synthesis of silica aerogel is well known, heavily documented and is available in published literature where tetraethyl orthosilicate (TEOS) or tetramethylorthosilicate (TMOS) is used as silica precursor. The typical procedure includes mixing of precursor in ethyl or methyl alcohol adding water as hydrolysing process and acid or base as a catalyst to complete the sol-gel reaction. The present innovation involves the steps where alcohol, water and catalyst are mixed, to which the diluted titanium precursor is added so that it reacts with water to form first hydroxide and then oxide i.e. titanium dioxide nanoparticles. The transparent milky colour with excellent dispersion in the liquid mixture confirms the formation nano titanium dioxide. Then silica precursor is added which undergoes hydrolysis and polycondensation to form silica network arresting nano titanium dioxide into the pores. Due to the nano size the volume of the titania nanoparticles increases and even 0.1 percent of titania particles almost doubles the infra red reflection properties when subjected to heat compared to the sample without presence of titanium dioxide. Rest all the process of aerogel formation including solvent exchange and supercritical drying remain same.

Once the gel is formed, the drying of the gel is performed by most popular super critical drying process to be carried out in an autoclave which can be performed using alcohol or liquid carbon dioxide as a solvent. Before drying, the solvent and water mixture in the gel is completely replaced by a pure alcohol or liquid carbon dioxide. There are advantages and limitations of either of the process of supercritical drying. If alcohol is used as a solvent, the process needs to be carried out at elevated temperatures above 250° C. and after venting it, the same can be easily water condensed and reused. However, this has higher power requirement and has the risk of handling highly flammable solvent. In other case of using liquid carbon dioxide which has lower critical temperature i.e. 31° C., the supercritical process can be performed at much lower temperature i.e. at 40° C. This process takes longer autoclave operation where total process may take 3 to 4 days. This process needs extra facility to scrub or re-condense the vented carbon dioxide during drying process. Being a green house gas, if released in atmosphere, the carbon footprint is very high for the process. In case of leakage due to any reason, the increased concentration of carbon dioxide in air may become lethal for life. In both the cases, requirement of high pressure is a common parameter. The ethanol is a preferred alcohol as a solvent in the drying process with the advantage of its higher critical temperature at 243° C. which helps to initiate the crystallization process of the nano titania loaded silica gels which can not happen if liquid carbon dioxide is used as a drying solvent.

Controlling the surface chemistry of silica aerogel is extremely important. The hydrophobic nature of silica aerogels is most preferred as it avoids the atmosphere moisture and rain water absorption and protects the insulation property. The hydrophobic silica aerogels are formed mainly by two methods. The first method is the silica gel surface modification by alkilation process. As prepared silica gel surface is covered with hydroxyl groups which makes silica aerogel hydrophilic. The hydroxyl groups are reacted with some alkoxy compounds such as hexamethyldisilazane, methyl trimethoxysilane, trimethylchlorosilane to convert them to a group ending with alkyl group. This process is called as alkilation. If the silane containing chemicals are used for this purpose, the process is called as silation. These gels after alkilation or silation treatment are dried either by super or sub critical drying to produce hydrophobic silica aerogels. In second method, silica precursor or a combination of precursors is selected such that it contains at least one alkyl group in the precursor molecule. Hexamethyldisilazane, methyl trimethoxysilane are the most preferred precursors for producing hydrophobic silica aerogels. Other way is that the alkyl group containing precursors can be added in a proportion to other silica precursors as a hydrophobising agent during the sol preparation stage of the synthesis. The ethanol drying process carried out at higher temperature above 250° C., enhances the reaction of surface hydroxyl groups with hydrophobising agent and ethanol molecule itself to increase the hydrophobic nature of silica aerogel.

As described above, the infra red reflecting pure silica aerogel with smaller fraction of opacifier generated in-situ and with hydrophobic nature are produced by simple way following preferably ethanol based supercritical drying method. The flexible sheet form of silica aerogel sheet with fibre reinforcement is the most successful product which is available commercially. The prior art describes all the claimed process for making the same. The general procedure for making such flexible sheets is preparation of silica sol which is in-filtered in the mat of non-woven fibres followed by gelation of the in-filtered sol to form the fibre and gel wet composite., After drying this composite sheet supercritically, flexible aerogel sheet is obtained. Basically, more the content of aerogel, higher is the thermal insulation property of the sheet. The content of aerogel in the sheet is determined by the porosity available or in turn density of the fibre mat used as reinforcement material. There is limitation, on the density based on their commercial availability and if used too low dense mat, the mechanical strength of the sheet is compromised. So the increase in the aerogel content in the sheet beyond certain value near to 50% is impossible. The present invention relates to increase the aerogel content by applying novel strategy where it can reach upto 90%.

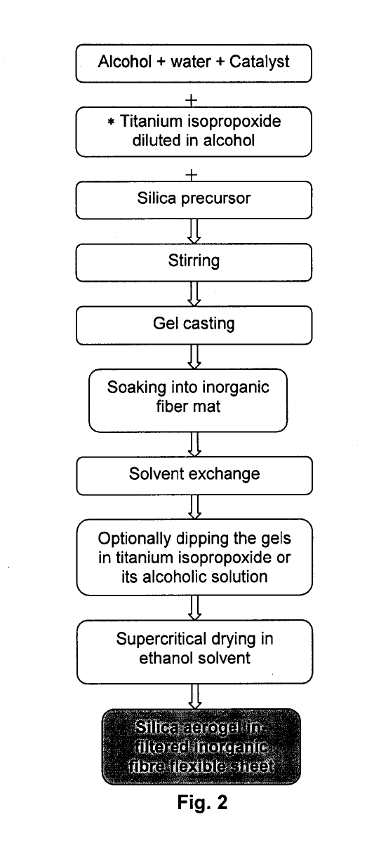

We had applied for a patent for the process of making aerogel granules by template method vide Indian patent application No. 2406/DEU2010 dated Oct. 8, 2010 where silica sol is in-filtered into the pores of organic sponge to make wet composite of silica gel and sponge. When dried supercritically in ethanol solvent, the ethanol supercritical temperature degrades the organic sponge releasing the aerogel granules in their pores. This invention is further taken ahead in this patent application to form flexible sheets as per the following process. Initially, the organic sponge sheet is placed in between two inorganic fibre mats as a sandwich structure and stitched using high temperature stable thread in a grid structure making pockets in the stitched sheet as shown in FIG. 2 but not limited to the shown stitching pattern. The thread used for stitching can be of any suitable thickness and composition depending upon the thickness of sheet and the usage temperature in the application. For usage at high temperature, the stitching thread is preferably made of the fibres or yarn of silica, silica-alumina, zirconia with or without re-inforced metal threads/metal threads. The silica sol is then soaked in these sheets where it gets absorbed by inorganic fibre mat as well as organic sponge sheet. The wet gel composite thus formed is subjected to solvent exchange and ethanol supercritical drying process where the middle layer of organic sponge degrades at supercritical temperature and releases the aerogel granules within the pockets of the stitched sheet, holding them in the sheet. There is no limit to number of such alternate layers of organic sponge and inorganic fibre mat and their thickness as long as they are able to stitch. With this we can increase the aerogel content in the sheet in a controlled way and as large as possible. The silica sol described earlier is used to make these sheets to gain all the infra red opacification properties. The organic sponge is selected which has degradation temperature more than or equal to 250° C. so that the organic part of the sponge is completely degraded during the supercritical drying process to releases the aerogel granules trapped in its pores. For this purpose the range of polymeric sponges made up of polymers like but not limited to polyethylene, polypropylene, polyolefin, polyurethane, polyvinyl chloride more preferably polyurethane. The pore sizes and the total porosity in the organic sponge determine the final aerogel granule size and the quantity of the aerogel granules respectively. Hence the selection of the organic sponge should be done depending on the desired size of the aerogel granules and it should be highly porous so as to produce larger quantity of aerogels granules per volume of the organic sponge.

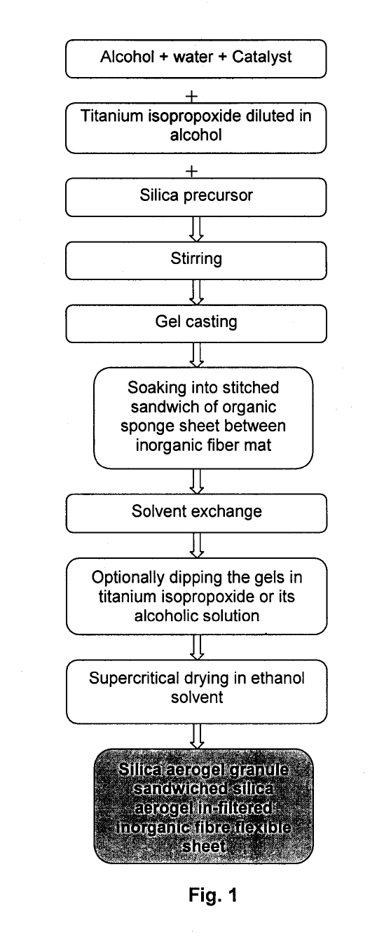

Hence we have come out with an improved process for producing silica aerogel thermal insulation product having titanium dioxide formed in situ capable of suppressing radiative heat transport as shown in the flow diagram in FIG. 1. It comprise of the following steps:
a) preparing an aqueous solution of alcohol selected from methanol, ethanol, isopropanol preferably ethanol, in which an aqueous solution of ammonium fluoride and ammonia solution is added as alkaline catalysts;
b) addition of metal oxide precursor preferably titanium isopropoxide in alcohol as titania precursor and dissolve in into the solution of step (a) during which titania nano particles are precipitated in the solution;
c) mixing silica precursor comprising alkoxides of silica selected from tetramethylorthosilicate (TEOS), tetraethyl orthosilicate, hexamethyldisiloxisilane, methyl trimethoxisilane (MTMS), sodium silicate, more preferably TEOS and MTMS, individually or in combination, in the dispersion formed in the step (b);
d) stirring the resulting mixture continuously till the total mixture starts becoming viscous;
e) soaking an inorganic fiber mat in the liquid formed in step (c), wherein the inorganic fibre mat is having two or more layers with organic sponge sheet placed in between the layers and stitched together to form a sandwich sheet of desired size, shape and thickness
f) ageing the resultant product of step (e) for 1-24 hr at room temperature;
g) immersing the resultant product (f) in pure solvent preferably ethanol to replace all the original solvent and water mixture used in step (a) for at least 3 days;
h) replacing the solvent and water mixture used in step (a) every day with the fresh batch of said pure solvent till the complete exchange of liquid present in gel is replaced by the solvent;
i) subjecting the resultant product to supercritical temperature by keeping the gel in a pressure vessel filled with said solvent used in step (g) and maintain a temperature of 260° C. to 350° C., and pressure of 80 bars to 150 bars for 0.2 to 3 hours;
j) venting out the vapours of the solvent completely at the rate of about 0.5 bar/min from the pressure vessel by opening the release valve and putting off the heater to cool down the pressure vessel and recovering the silica aerogel products from the pressure vessel.

In another embodiment under the invention said inorganic fibre mat of desired size, shape and thickness is soaked in an inorganic fibre mat in the liquid formed in step (d) instead of said sandwich sheet as shown in the flow diagram in FIG. 2.

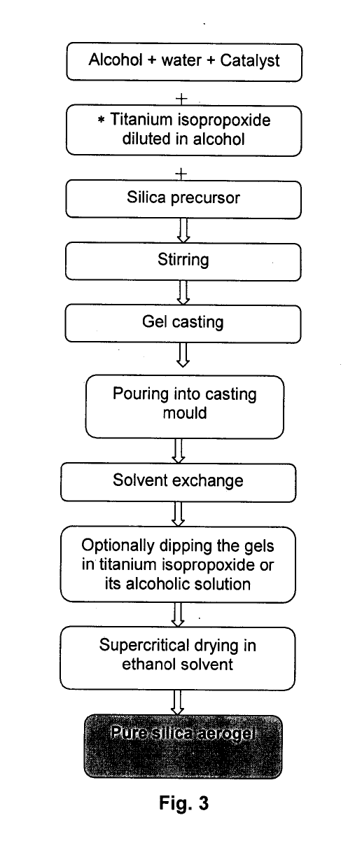

In yet another embodiment under the invention the liquid formed in step (d) is poured into the mould to form the silica gel in pure form having the desired size, shape and thickness as shown in the flow diagram in FIG. 3.

Now various steps involved in the process of making such silica aerogel in pure form and flexible sheet form are explained in details in the following paragraphs along with examples.

### 1) Step of Preparing Silica Sol

Initially a stirred reactor is charged with a solvent such as either one or the mixture of methanol, ethanol, isopropyl alcohol. To this, water is added as a hydrolyzing agent in a certain proportion. The catalyst, preferably alkali such as ammonia solution, ammonium fluoride, ammonium hydroxide and sodium hydroxide, more preferably ammonia solution and ammonium fluoride in aqueous solution form are added to the mixture of solvent and water. Optionally, solution of metal oxide precursor of metals such as but not limited to iron, manganese, magnesium, zirconium, zinc, chromium, cobalt, titanium, tin, indium etc or mixtures of them is prepared in a separate container. Most preferably the titanium precursor such as titanium isopropoxide, butoxide, tetrachloride, trichloride, sulphonate more preferably titanium isopropoxide is diluted using the same solvent which was used in earlier step. This diluted titanium precursor is then added to the mixture of solvent, water and catalyst. The solution becomes milky white in few seconds. Then predetermined quantity of silica precursor such as tetramethylorthosilicate, tetraethyl orthosilicate, hexamethyldisiloxisilane, methyl trimethoxisilane sodium silicate or combination of them, more preferably mixture of tetraethyl orthosilicate (TEOS) which is also commercially known as ethyl silicate and methyl trimethoxysilane (MTMS) are added to the milky white solution. The total mixture is then mildly stirred and observed it for the beginning of the increase in viscosity. The concentration ratio of precursor:solvent is used preferably between 1:4 to 1:50 moles and the ratio of TEOS and MTMS precursors used is between 5:1 to 5:5. The catalyst concentration used is preferably between 1:0.05 to 1:0.1 moles. The precursor-water molar ratio used is preferably in the range of 1:0.5 to 1:4 moles.

### II) Step of Casting the Gel

The sol prepared in step I is then poured in any desired shape and size container preferably plastic or glass container. The sol solidifies to form a gel in some time. This gelation time can be within 2 minutes to 24 hours depending upon the reactant concentrations.

In another embodiment, the sol prepared in step I is soaked in the pores of inorganic flexible fibre mat of any desired thickness and length. The sol in the pores of the inorganic fibre mat is converted into gel to composite of inorganic fibre mat and wet gel. The inorganic fibre mat used can be made up of woven or non woven ceramic fibres, refractory fibres, glass fibres, e glass fibres, any other oxide or mixture of oxide fibres of any desired thickness, size and density.

In one more embodiment, the sol prepared in the step I is soaked in the layered structured flexible sheet made up of inorganic fibre mat and organic sponge. This composite mat of inorganic fibre and organic sponge is prepared by stitching two layers of inorganic fibre mat with organic sponge sheet sandwiched between them in a grid structure as shown in the FIG. 2 which is a representative grid structure but not limited to this pattern. The thread used for stitching can be of any suitable thickness and composition depending upon the thickness of the sheet and the usage temperature in the application. For usage at high temperature, the stitching thread is preferably made up of the fibers or yarn of silica, silica-alumina, zirconia with or without metal thread re-inforcing and metal threads. There is no limit to number of such alternate layers of organic sponge and inorganic fibre mat and their respective thickness as long as they are able to stitch. Organic sponge selected is made up of polymers like but not limited to polyethylene, polypropylene, polyolefin, polyurethane, polyvinyl chloride more preferably polyurethane of desired pore size. The inorganic fibre mat used can be made up of woven or non woven ceramic fibres, refractory fibres, glass fibres, e glass fibres, any other oxide or mixture of oxide fibres of any desired thickness, size and density.

All the types of casted gels in pure or composite forms as described above are then are then further kept undisturbed in air tight container for completing the cross linking reaction and aging for about one day and subjected to solvent exchange process to make them ready for supercritical drying. Optionally, these gels are immersed in the titanium isopropoxide or its solution before going to the next step in the preparation process.

### III) Step of Supercritical Drying

The solvent exchanged gel prepared in step II is then placed in the high pressure reactor and then the solvent preferably ethanol is pored to cover the gel completely. The reactor is closed and slowly heated to the temperature upto 260° C. The pressure developed during heating is maintained at 80-150 bar at 260-350° C. Once these temperature and pressure conditions are achieved in the high pressure reactor, it is maintained for 0.2-3 hours as a soaking period. Then the pressure is released slowly at the rate of 0.5-0.1 bar/min by venting the ethanol vapours in the reactor. The vented ethanol vapours as collected by liquefying them in cool water condenser connected to the vent valve. Once the pressure reaches the atmospheric pressure, the heater is made off and the reactor is allowed to cool naturally. The silica aerogel products are collected from the cooled reactor.

The invention is described in details with reference to the Examples given below which are provided solely to illustrate the invention and hence should not be construed to limit the scope of the invention.

### Example 1

In the first step, 412 ml ethanol, 385 ml distilled water, 16.5 ml NH₄F (0.5M) and 1.65 ml NH₃ solution taken in flat round bottom flask under stirring. The titanium 2.75 ml isopropoxide was diluted in 165 ml of ethanol and added to above mixture slowly. Then 275 ml tetraethoxyorthosilicate and 110 ml of methyl trimethoxysilane was added to this mixture while stirring. The resulting sol was transferred into a plastic container where it was converted into gel in 5-7 minutes. Thus formed gel was kept for aging to strengthen the gel network at room temperature for ˜1 day. Finally, the gel was removed form the plastic container and immersed into ethanol for 3 days to exchange the liquid and bi-products inside the gel. The ethanol was replaced with a fresh lot everyday. The gel was then submitted to high temperature supercritical drying in the pressure reactor. The reactor temperature and pressure was raised to 260° C. and 80 bars pressure. This temperature and pressure condition was maintained for 180 minutes. Then the vapours in the reactor were vented completely at 0.5 bar/min rate and then the heater was made off to cool down the reactor. The highly porous silica aerogels with hydrophobic property and having loading of titania nanoparticles were obtained after opening the cooled reactor. The graph in FIG. 3 is a chemical analysis of the aerogel formed by energy dispersive x-ray analysis (EDAX) where presence of titanium element is seen.

### Example 2

In the first step, 375 ml ethanol, 350 ml distilled water, 25 ml NH₄F (0.5M) and 1.5 ml NH₃ solution taken in a beaker under stirring. The titanium 5 ml isopropoxide was diluted in 150 ml of ethanol and added to above mixture slowly. Then 250 ml tetraethoxyorthosilicate and 100 ml of methyl trimethoxysilane was added to this mixture while stirring. This sol was soaked in 10 mm thick ceramic fibre non-woven blanket of 30 cm×30 cm size. Within 5-10 minutes the sol soaked in the fibre blanket was solidified. Thus formed composite gel was kept for aging in an air tight plastic container to strengthen the gel network at room temperature for ˜1 day.

Finally, the composite gel was removed form the plastic container and immersed into ethanol for 3 days to exchange the liquid and bi-products inside the gel. The ethanol was replaced with a fresh lot everyday. The gel was then submitted to high temperature supercritical drying in the pressure reactor. The reactor temperature and pressure was raised to 260° C. and 80 bars pressure. This temperature and pressure condition was maintained for 180 minutes. Then the vapours in the reactor were vented completely at 0.5 bar/min rate and then the heater was made off to cool down the reactor. The highly porous silica aerogels flexible sheet re-inforced with ceramic fibres with hydrophobic property and having loading of titania nanoparticles were obtained after opening the cooled reactor.

### Example 3

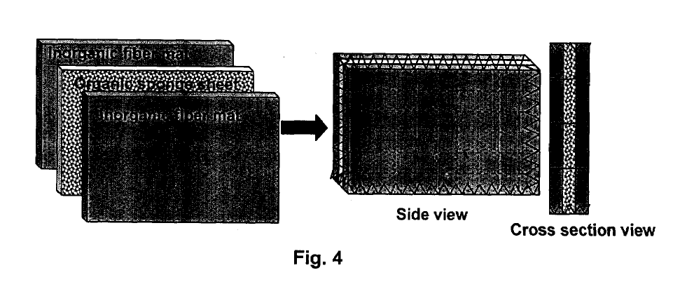

The silica aerogel prepared as per the procedure described in Example 2 except where in place of 5 ml titanium isopropoxide, 0.5 ml is added which leads to in-situ formation of about 0.1% titanium dioxide in the final product. In another experiment no titanium isopropoxide is added. to get pure silica aerogel flexible sheet sample without any titanium dioxide The infra red radiation reflection property was tested for these two samples with 0.1% titanium dioxide and no titanium dioxide after heating it in air at 400° C. FIG. 4 depicts the increase in the infra red reflectivity in the wavelength range of 3-7 μm due to the presence of titanium dioxide which is ≤1% in concentration compared to the sample with no titanium dioxide.

### Example 4

Two pieces of ceramic fibre non-woven blanket of about 5 mm thickness with 30 cm×30 cm size were taken. Then two number of polyurethane foam sheet of 2 mm thickness and 30 cm×30 cm size were cut. These two cut sheets of polyurethane foam were placed between the two ceramic fibre non-woven blankets. The total sheet layers thus formed were stitched using six layers of silica thread to form a stitched blanket as shown in FIG. 1.

The sol is prepared by first mixing 375 ml ethanol, 350 ml distilled water, 25 ml NH₄F (0.5M) and 1.5 ml NH₃ solution taken in a beaker under stirring. The titanium 5 ml isopropoxide was diluted in 150 ml of ethanol and added to above mixture slowly. Then 250 ml tetraethoxyorthosilicate and 100 ml of methyl trimethoxysilane was added to this mixture while stirring. This sol was soaked in the stitched blanket of ceramic fibre and polyurethane sponge as described earlier. Within 5-10 minutes the sol soaked in the stitched blanket was solidified. Thus formed composite gel was kept for aging in an air tight plastic container to strengthen the gel network at room temperature for ˜1 day. Finally, the composite gel was removed form the plastic container and immersed into ethanol for 3 days to exchange the liquid and bi-products inside the gel. The ethanol was replaced with a fresh lot everyday. The gel was then submitted to high temperature supercritical drying in the pressure reactor. The reactor temperature and pressure was raised to 260° C. and 80 bars pressure. This temperature and pressure condition was maintained for 180 minutes. Then the vapours in the reactor were vented completely at 0.5 bar/min rate and then the heater was made off to cool down the reactor. The highly porous silica aerogels flexible sheet having silica granules sandwiched and placed in the pockets of the stitched blanket with hydrophobic property and having loading of titania nanoparticles were obtained after opening the cooled reactor.

### Example 5

The nitrogen adsorption studies were carried out on the samples prepared as per the procedure described in Example 2 and 4 and the two commercially available silica aerogel flexible sheets re-inforced with inorganic fiber mat which are prepared as per the process described in the patents from prior art. The nitrogen adsorption studies were carried out as per the standard procedure which includes important steps as follows. The sample was accurately weighed and heated in vacuum at 300° C. for 3 hours prior to the analysis. Then these samples were kept in liquid nitrogen bath to attain the liquid nitrogen temperature. Then the extra pure quality nitrogen gas was dosed to the sample to allow it to adsorb on the available surface area in the sample. The dosage was continued till the pressure ratio of P/P₀ is 0.99 to obtain the isotherm graph of quantity of nitrogen adsorbed in cm³/g vs P/P₀. Using this data and applying BJH standard theory, the data of cumulative pore volume vs pore size was generated.

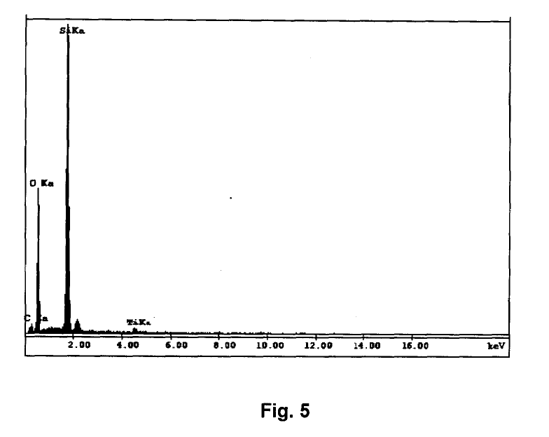

FIG. 5 gives the comparative graph on isotherm which plots the quantity of nitrogen adsorbed with respect to the relative partial pressure in nitrogen adsorption studies with the respective surface area for the silica aerogel in the flexible sheet prepared by a method as described in Example 2 and Example 4 and their comparison with the two samples which are commercially available and prepared by the process described in the patents mentioned in the prior art. It is evident that the samples prepared by the process mentioned in this invention, show much higher porosity.

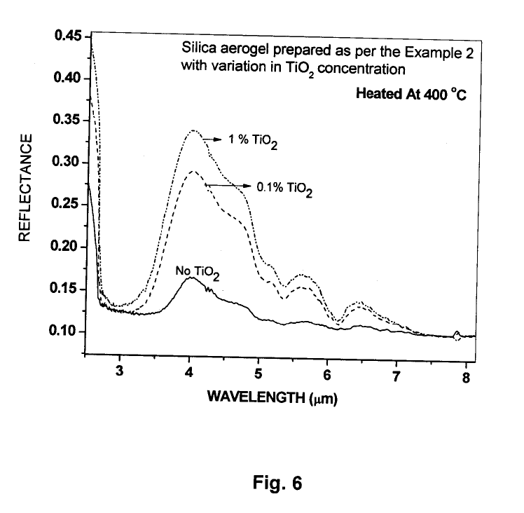

FIG. 6 shows the comparative graph on cumulative pore volume for the silica aerogel in the flexible sheet prepared by a method as described in Example 2 and Example 4 and their comparison with the two commercially available samples prepared by the process described in the patents mentioned in the prior art. It is very clear that the flexible sheet having silica aerogel granules sandwiched between two ceramic fibre re-inforced silica aerogel sheets prepared as per example 4 possess extra content of aerogel, hence possess more pore volume and hence will possess the greater thermal insulation property.

### Advantages of the Invention

1. The process produces
   Slica aerogel having dispersion of nano titanium dioxide nanoparticles which are prepared in-situ while formation of silica gel network.
   Silica aerogel having dispersion of metal oxide nanoparticles, preferably titanium dioxide nanoparticles which are prepared in-situ while formation of silica gel network in-filtered into the inorganic fibre non-woven blanket to form infra red reflecting flexible insulation sheets when applied on hot surface. Silica aerogel having dispersion of preferred nano titanium dioxide nanoparticles which are prepared in-situ while formation of silica gel network in-filtered into the inorganic fibre non-woven blanket to form infra red reflecting flexible insulation sheets when applied on hot surface.
   Silica aerogel flexible sheet where the infra red reflecting silica aerogel granules are sandwiched and placed in the pockets between two the infra red reflecting silica aerogel in-filtered flexible sheets of ceramic fibre blanket or their multilayer structures.
   Silica aerogels in all forms described in this invention having nanoporous surface area greater than 300 m²/g which is important criteria for better thermal insulation property.
2. The process is cost effective as the metal oxide nanoparticles, preferably titanium dioxide nanoparticles are required in smaller quantity even ≤2% than conventionally used micron size particles and is a single step easy process to incorporate them into silica aerogel network with uniform distribution.
3. The process facilitates increasing the silica aerogel content in the flexible sheet and increasing the ability to have better thermal insulation property.

We have brought out the novel features of the invention by explaining some of the preferred embodiments under the invention, enabling those skilled in the art to understand and visualize our invention. It is also to be understood that the invention is not limited in its application to the details set forth in the above description. Although the invention has been described in considerable detail with reference to certain preferred embodiments thereof, various modifications can be made without departing from the spirit and scope of the invention as described herein above and as defined in the following claims.

1.-18. (canceled)

19. A method for preparation of a silica aerogel thermal insulation product, the method comprising:
(a) preparing a hydro-alcoholic solution containing at least one alkali;
(b) adding a solution of a metal oxide precursor to the hydro-alcoholic solution to form a dispersion effecting in-situ formation and precipitation of nanoparticles of at least one metal oxide, wherein the metal oxide precursor comprises one or more metals selected from the group consisting of iron, manganese, magnesium, zirconium, zinc, chromium, cobalt, titanium, tin, and indium;
(c) mixing at least one silica precursor with the dispersion to form a first mixture;
(d) stirring the first mixture to obtain a viscous mixture with the nanoparticles entrapped therewithin;
(e) aging the viscous mixture to form an aged viscous mixture; and
(f) effecting supercritical drying of the aged viscous mixture, to obtain the silica aerogel thermal insulation product.

20. The method of claim 19, wherein the at least one silica precursor is selected from the group consisting of tetraethylorthosilicate, tetramethylorthosilicate, hexamethyldisiloxane, methyl trimethoxysilane, and sodium silicate, individually or in combination.

21. The method of claim 19, wherein aging comprises aging of the viscous mixture for a time period ranging from about one hour to about twenty-four hours at a room temperature.

22. The method of claim 19, further comprising effecting a solvent exchange before effecting supercritical drying of the aged viscous mixture, wherein the solvent exchange comprises immersing the aged viscous mixture in an alcoholic solvent for about three days while replacing the alcoholic solvent with a fresh batch of alcoholic solvent approximately daily.

23. The method of claim 22, wherein the alcoholic solvent further comprises the metal oxide precursor.

24. The method of claim 19, wherein effecting supercritical drying of the aged viscous mixture comprises:
(a) maintaining the aged viscous mixture in a pressure vessel filled with the alcoholic solvent, wherein the pressure vessel is maintained at a temperature ranging from about 260° C. to about 350° C. and at a pressure ranging from about 80 bars to about 150 bars for a time period ranging from about 0.2 hours to about 3 hours; and
(b) allowing the pressure vessel to cool down while venting out solvent vapours at a rate of about 0.5 bar/minute.

25. The method of claim 19, wherein the metal oxide precursor is titanium isopropoxide, titanium butoxide, or a combination thereof.

26. The method of claim 19, wherein the method further comprises impregnating an inorganic fibre mat with the viscous mixture before aging and supercritical drying of the viscous mixture, wherein the inorganic fibre mat comprises an individual inorganic fibre mat, a pair of individual inorganic fibre mats with an organic sponge sandwiched therebetween, or a combination thereof.

27. The method of claim 26, wherein the individual inorganic fibre mat comprises a woven fabric made of one or more materials selected from the group consisting of ceramic fibres, refractory fibres, glass fibres, e-glass fibres, and oxide fibres.

28. The method of claim 26, wherein the individual inorganic fibre mat comprises a non-woven fabric made of one or more materials selected from the group consisting of ceramic fibres, refractory fibres, glass fibres, e-glass fibres, and oxide fibres.

29. The method of claim 26, wherein the organic sponge comprises one or more polymers selected from the group consisting of polyethylene, polypropylene, polyolefin, polyurethane, and polyvinyl chloride.

30. The method of claim 26, wherein the inorganic fibre mat comprises the pair of individual inorganic fibre mats with the organic sponge sandwiched therebetween, and wherein the supercritical drying of the viscous mixture impregnated in the pair of individual inorganic fibre mats degrades the organic sponge.

31. The method of claim 19, wherein the method further comprises casting the viscous mixture in a mold before aging and supercritical drying of the viscous mixture.

32. The method of claim 19, wherein the solution of the metal oxide precursor is an alcoholic solution containing a precursor of titanium dioxide in an amount of less than or equal to 5% by weight of the alcoholic solution.

33. The method of claim 19, wherein the at least one silica precursor and the metal oxide precursor are utilized in a molar ratio ranging from about 1:0.0014 to about 1:0.7.

34. The method of claim 19, wherein molar ratio of the at least one silica precursor to an alcohol present in the hydro-alcoholic solution ranges from about 1:4 to about 1:50, and wherein molar ratio of the at least one silica precursor to water present in the hydro-alcoholic solution ranges from about 1:0.5 to about 1:4, and wherein the at least one silica precursor comprises a combination of tetraethylorthosilicate and methyl trimethoxysilane in a molar ratio ranging from about 5:1 to about 5:5.

35. The method of claim 19, wherein the at least one alkali and the at least one silica precursor are utilized in a molar ratio ranging from about 1:0.05 to about 1:0.1.

36. The method of claim 19, wherein the silica aerogel thermal insulation product comprises silica aerogel with a specific surface area of about 300 m²/g.

37. The method of claim 19, wherein the silica aerogel thermal insulation product is substantially devoid of Si—O—Ti.

38. The method of claim 19, wherein the hydro-alcoholic solution comprises methanol, ethanol, isopropanol, or a combination thereof.
